(19) United States
(12) Patent Application Publication
(10) Pub. No.: US 2020/0003206 A1
(43) Pub. Date: Jan. 2, 2020

(54) Hydrostatic Axial Piston Pump for a Hydrostatic Traction Drive

(71) Applicant: Robert Bosch GmbH, Stuttgart (DE)

(72) Inventors: Matthias Mueller, Langenau (DE); Ronny Herrmann, Neu-Ulm (DE); Steffen Mutschler, Neu-Ulm (DE); Ulrich Lenzgeiger, Dinkelscherben (DE)

(21) Appl. No.: 16/453,539

(22) Filed: Jun. 26, 2019

(30) Foreign Application Priority Data
Jun. 29, 2018 (DE) 10 2018 210 694.0

(51) Int. Cl. F04B 49/12; F04B 19/22; F04B 49/06

(52) U.S. Cl. CPC F04B 49/12; F16H 61/461; F04B 49/06; F04B 19/22

(57) ABSTRACT

A hydrostatic axial piston pump for a hydrostatic traction drive has an adjusting unit for adjusting the stroke volume. The adjusting unit has an actuating cylinder with two counteracting actuating pressure chambers. An actuating pressure can be set in each actuating pressure chamber via a separate pressure reducing valve, the said actuating pressure depending on and preferably being proportional to a current intensity on a respective solenoid of the respective pressure reducing valve. The two current intensities can be calculated via an electronic control unit on a model basis as a function of a speed and of an operating pressure of the axial piston pump and as a function of an operating element for a driver's request, e.g. an accelerator pedal.

This application claims priority under 35 U.S.C. § 119 to application no. DE 10 2018 210 694.0, filed on Jun. 29, 2018 in Germany, the disclosure of which is incorporated herein by reference in its entirety.

### TECHNICAL FIELD

The disclosure relates to a hydrostatic axial piston pump for a hydrostatic traction drive.

### BACKGROUND

Hydrostatic traction drives are known, for example for mobile working machines, in which a hydrostatic axial piston pump and one or more hydrostatic motors are connected to one another in a closed hydraulic circuit. The pump is driven by an internal combustion engine, for example a diesel engine, and the motors drive, for example, respective wheels of the mobile working machine.

The axial piston pumps of such traction drives are often adjustable in their stroke volume. Therefore, for example with a constant rotational speed of the internal combustion engine, the volume flow delivered by the axial piston pump in the closed circuit can be changed, and therefore an output rotational speed of the motors or of the wheels, that is to say a speed of travel of the mobile working machine, can be adjusted.

The prior art discloses output rotational speed controls and controllers having feedback of the adjustment of the stroke volume of the axial piston pump (so-called EP pumps). In the case of axial piston pumps of swash-plate design, an actual pivoting angle of the swash plate is fed back in this case.

Also known from the prior art are automatic rotational speed-dependent (DA) adjusting units for axial piston pumps, in which a control valve produces an actuating pressure which depends on the drive rotational speed of the axial piston pump and on the operating pressure in the hydraulic circuit. This actuating pressure is fed to the actuating cylinder of the axial piston pump by a solenoid-operated 4/3-way valve. The dependence of the actuating pressure on the operating pressure provides a sensitivity to load, which may be disadvantageous.

### SUMMARY

The basis of the disclosure to devise an axial piston pump for a traction drive of which the speed control is load-independent, wherein control technology with complicated device-based feedback is to be avoided.

This object is achieved by an axial piston pump having the features described herein.

The disclosed hydrostatic axial piston pump is preferably implemented in a swash-plate design and is designed as a primary unit for a hydrostatic traction drive. The axial piston pump has an adjusting unit for adjusting its stroke volume. The adjusting unit has an actuating cylinder with a first actuating pressure chamber, in which a first actuating pressure can be set via a first pressure reducing valve. The actuating pressure depends on a preselected first current intensity on a first solenoid of the first pressure reducing valve. According to the disclosure, the first current intensity is calculated via an electronic control unit as a function of an actual rotational speed and of an operating pressure of the axial piston pump and as a (possibly indirect) function of an operating element for the driver's request. The operating element can be, for example, an accelerator pedal of the mobile working machine. Therefore, the axial piston pump according to the disclosure is suitable for a traction drive of which the speed control of the mobile working machine concerned is load-independent. Various modes of rotational speed control of the output of the traction drive concerned are possible. Here, neither controller nor any control technique having complicated device-based feedback is necessary.

In a particularly preferred development, in pump operation of the axial piston pump according to the disclosure, the actual rotational speed and the first actuating pressure act in the direction of an increase in the stroke volume or in the pivoting angle, while the operating pressure acts in the direction of a reduction in the stroke volume or in the pivoting angle.

In a particularly preferred development, the actuating cylinder has a second actuating pressure chamber, which acts counter to the first actuating pressure chamber, and in which a second actuating pressure can be set via a second pressure reducing valve. This is done independently for the two actuating pressure chambers. The second actuating pressure depends on a preselected second current intensity on a second solenoid of the second pressure reducing valve. In addition, the second current intensity is calculated by the electronic control unit as a function of the actual rotational speed and of the operating pressure of the axial piston pump and as a function of the operating element. Therefore, the second actuating pressure acts in the direction of the reduction in the stroke volume. In this case, the difference between the first actuating pressure and the second actuating pressure can be designated as an effective actuating pressure difference. Therefore, the axial piston pump is also controllable, according to the disclosure, if it changes to a motor mode, which can arise as a result of overrun operation of the traction drive concerned.

In a particularly preferred development, the pressure reducing valve or the two pressure reducing valves is or are proportional, so that the respective actuating pressure is proportional to the respective current intensity. Therefore, proportional speed control and proportional driving modes are possible.

In a particularly preferred development, at least one characteristic map and/or a plurality of characteristic curves and/or at least one formula is/are stored in the control unit, via which map, curves or formula the current intensity can be calculated, or via which map, curves or formula the two current intensities can be calculated. In the characteristic map or in the characteristic curves or in the formula, physical relationships (e.g. an output characteristic, pressure-dependent restoring forces, spring characteristic curves) of the axial piston pump are stored or mapped. These physical relationships can have been determined in advance, either on exactly the axial piston pump or on an identically constructed sample.

In a particularly preferred development, a target pivoting angle of the axial piston pump can be calculated via the electronic control unit in an intermediate step on a model basis as a function of the operating element. Then, the current intensity or the current intensities is or are calculated as a function of this target pivoting angle and of the actual rotational speed and of the actual operating pressure.

Here, the target pivoting angle can be calculatable by using a volume flow balance “Qₚₘₚ+Qₗₑₐₖ=Qₘₒₜ”.

In the control unit, it is also possible for an output-guided actuating pressure, which is minimally linked is minimally linked with the (rotational speed-based calculated) first actuating pressure or with the actuating pressure difference, to be calculatable. Therefore, the load-independent speed control and the various modes of the rotational speed control of the output of the traction drive concerned are possible with simultaneous limitation of the output (e.g. as an overload safeguard). Therefore, simple implementation of a speed limit in output-guided traction drives is also possible.

With feedback of the speed of the mobile working machine, a speed controller (closed loop) can be formed. The latter is then particularly stable and robust and is capable of correcting errors in the characteristic map-based or formula-based actuating pressure control according to the disclosure, which can arise, for example, as a result of wear of the axial piston pump.

### BRIEF DESCRIPTION OF THE DRAWINGS

An exemplary embodiment of an axial piston pump according to the disclosure is illustrated in the figures, in which:

FIG. 1 shows a circuit diagram of the exemplary embodiment of the axial piston pump according to the disclosure,

FIG. 2 shows a first logic diagram of an electronic control unit of the axial piston pump from FIG. 1,

FIG. 3 shows a further logic diagram of the electronic control unit of the axial piston pump from the preceding figures,

FIG. 4 shows a characteristic map of the electronic control unit of the axial piston pump from the preceding figures,

FIG. 5 shows a characteristic curve of the electronic control unit of the axial piston pump from the preceding figures, and

FIG. 6 shows a characteristic map of the electronic control unit of the axial piston pump from the preceding figures.

### DETAILED DESCRIPTION

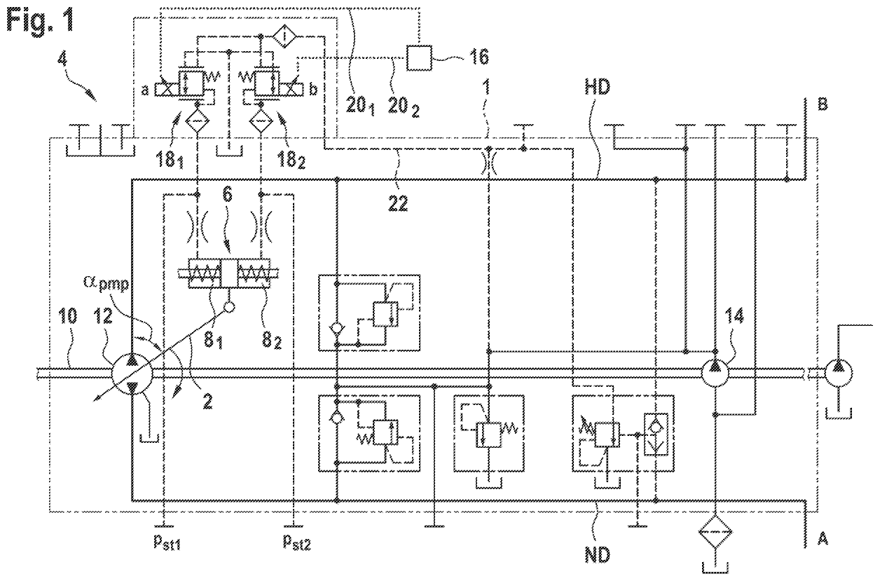

FIG. 1 shows a circuit diagram of the exemplary embodiment of the axial piston pump according to the disclosure. Only the components of the axial piston pump that are relevant to the disclosure are described. The axial piston pump has a casing 1, on which there are formed two working connections A, B, to each of which a working line (not shown) of a closed circuit is connected. A traction drive for a mobile working machine (not shown) is formed therewith.

The axial piston pump is implemented with a swash plate 2, of which the pivoting angle αₚₘₚ can be set via an adjusting unit 4. Here, use is made of a double-acting actuating cylinder 6 which has a first actuating pressure chamber 8₁ and a second actuating pressure chamber 8₂ acting counter thereto.

A first control pressure pₛₜ₁ acts in the first actuating pressure chamber 8₁ in the direction of an increase in the pivoting angle αₚₘₚ and therefore in the direction of an increase in the stroke volume Volₚₘₚ of the axial piston pump. This is counteracted by a second actuating pressure pₛₜ₂ in the second actuating pressure chamber 8₂ in the direction of a reduction in the pivoting angle αₚₘₚ and therefore in the direction of a reduction in the stroke volume Volₚₘₚ of the axial piston pump. It is therefore possible to define an actuating pressure difference Δpₛₜ=pₛₜ₁−pₛₜ₂, wherein this actuating pressure difference Δpₛₜ by definition always acts in the direction of an increase in the pivoting angle αₚₘₚ and in the stroke volume Volₚₘₚ.

Via a drive shaft 10 of the axial piston pump, its drive mechanism 12 and, going beyond this, also a feed pump 14 is driven. The drive shaft 10 is driven by a diesel engine (not shown) and rotates at a rotational speed nₚₘₚ. This rotational speed nₚₘₚ acts together with the actuating pressure difference Δpₛₜ in the direction of an increase in the pivoting angle αₚₘₚ. More precisely, an increase in the rotational speed nₚₘₚ acts in this way.

If the axial piston pump shown supplies multiple traction motors of the mobile working machine via its working connections A, B, let it be assumed that B is the high-pressure connection during forward travel, so that the channel connected to the working connection B is characterized by high pressure HD, while the other channel, connected to the working connection A, is characterized by low pressure ND. The high pressure HD, which is also designated as operating pressure, acts in the direction of a reduction in the pivoting angle σₚₘₚ. These relationships are designated as a characteristic of the axial piston pump and are stored in an electronic control unit 16 as formulas and/or as characteristic maps or characteristic curves. In addition, the rotational speed nₚₘₚ and the actuating pressure difference Δpₛₜ and the high pressure HD are measured. Therefore, it is possible to move to operating points of the axial piston machine according to the disclosure without any feedback in the sense of a control loop being necessary for this purpose.

The two actuating pressures pₛₜ₁, pₛₜ₂ are controlled via two pressure reducing valves 18₁, 18₂. These each have an electric solenoid a, b, which are connected to the electronic control unit 16 via a respective electric line 20₁, 20₂. The two pressure reducing valves 18₁, 18₂ are designed in such a way that the respective actuating pressure pₛₜ₁, pₛₜ₂ is proportional to the respective current intensity I₁, I₂.

The inlets of the two pressure reducing valves 18₁, 18₂ are supplied by the feed pump 14 via a feed pressure line 22.

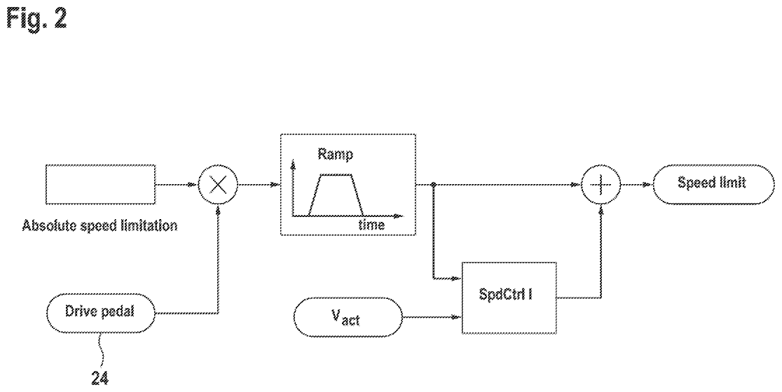

FIG. 2 shows a preparatory first logic diagram of the electronic control unit 16 from FIG. 1. A ramp over time is calculated from an absolute speed limit and from the position of the operating element 24 configured as an accelerator pedal. From this, by incorporating an actual speed v_{act} of the mobile working machine, a “speed limit” is calculated.

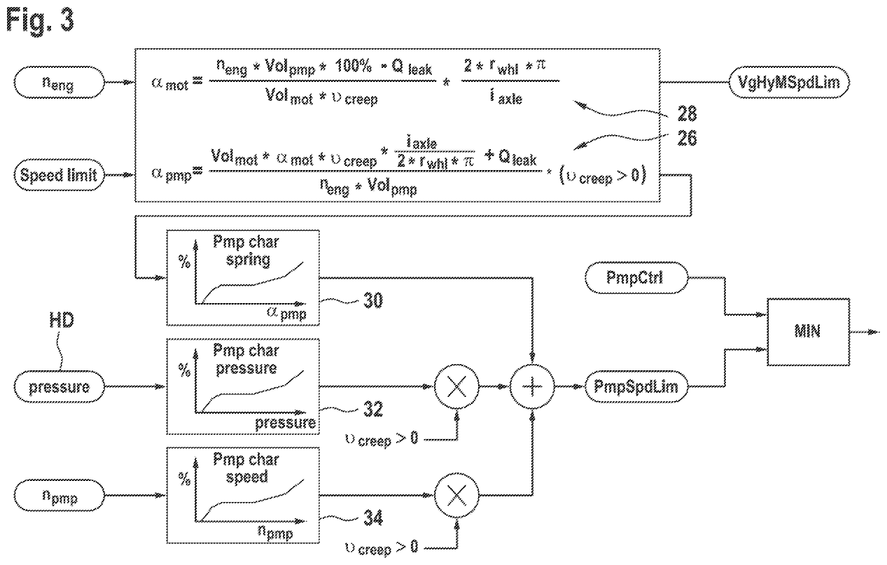

According to FIG. 3, the “speed limit”, together with a rotational speed n_{eng} of the internal combustion engine (not shown) is converted via a formula 26 into a target pivoting angle σₚₘₚ of the axial piston pump.

The hydraulic motor or motors (not shown) of the traction drive concerned is/are either constant-displacement motors, or the pivoting angle αₘₒₜ is determined and set in accordance with the formula 28.

“PmpSpdLim” is calculated by an addition of three values, which are determined with respective characteristic curves 30, 32, 34. In the first characteristic curve 30, the target pivoting angle σₚₘₚ previously calculated with the formula 26 is taken into account. In the second characteristic curve 32, the high pressure HD present in the working line is taken into account. In the third characteristic curve 34, the actual rotational speed nₚₘₚ of the drive shaft 10 (cf. FIG. 1) of the axial piston pump is taken into account.

The logic diagram of FIGS. 2 and 3 therefore shows the calculation of the target pivoting angle σₚₘₚ on the basis of the volume flow balance Qₚₘₚ−Qₗₑₐₖ=Qₘₒₜ. From the target pivoting angle αₚₘₚ, an actuating pressure is determined via the spring characteristic curve 30 and the characteristic curve 32 mapping the high pressure. In addition, via the rotational speed-dependent characteristic curve 34, the rotational speed-depended restoring forces are compensated. Instead of these characteristic curves 30, 32, 34, formulas (functional equations) can also be used.

The resultant actuating pressure acts in a limiting manner on a pump activation “PmpCtrl”, which limits the output as an overload safeguard.

The target value for the speed can be calculated simply from the operating element 24 and the maximum speed. In addition, the maximum dynamics are limited.

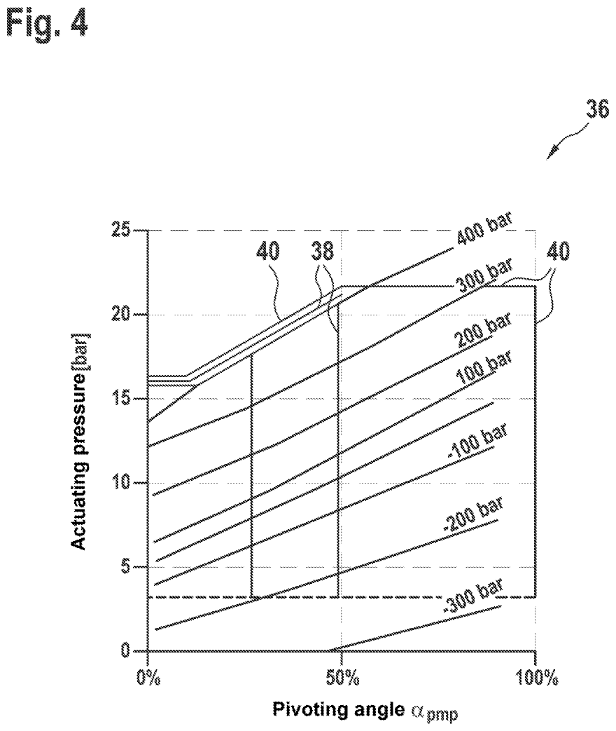

FIG. 4 shows a characteristic map 36, in which the relationship between the pivoting angle αₚₘₚ (x axis) and the first actuating pressure pₛₜ₁ and the actuating pressure difference Δpₛₜ (y axis) and the operating pressure HD (family of curves) mapped. The relationship of these three values that is shown is based on the real physical properties of the axial piston pump. Thus, for example, with a given operating pressure HD (e.g. 300 bar) at a target pivoting angle σₚₘₚ (e.g. 50%), determined via the operating element, a necessary actuating pressure pₛₜ₁ or an actuating pressure difference Δpₛₜ (about 17 bar in this example) can be determined by the electronic control unit 16, in order to supply the solenoids a, b of the two pressure reducing valves 18₁, 18₂ with the respective current intensity I₁, I₂ proportionally thereto.

Also illustrated in FIG. 4 are the boundaries of a pressure cut-off 38 and the boundaries of an output limit 40.

From rotational speed nₚₘₚ and calculated pivoting angle σₚₘₚ, in accordance with a pump characteristic curve the maximum permissible actuating pressure p_{St1} or the maximum permissible actuating pressure difference Δpₛₜ is determined which would necessitate the maximum permissible high operating pressure HD on the working connection A, B. If the actuating pressure output in accordance with the driver's request lies above this actuating pressure, it is limited.

If, therefore, the maximum permissible operating pressure HD (e.g. 450 bar) of the traction drive is reached, the pressure cut-off intervenes and cuts back the actuating pressure pₛₜ₁ or the actuating pressure difference Δpₛₜ. As a result, even with a load rising further, exceeding the maximum operating pressure HD can be avoided.

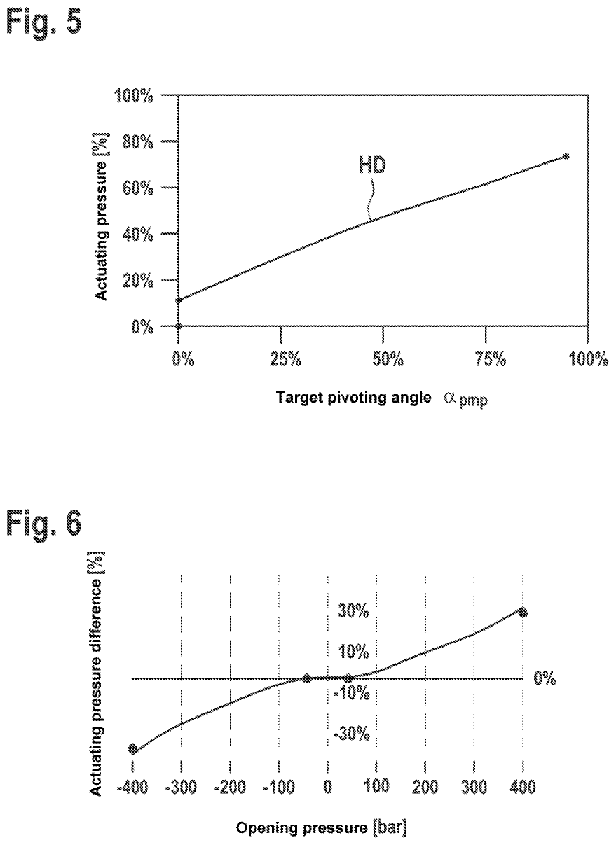

FIG. 5 shows a single characteristic curve on the principle of the characteristic map from FIG. 4. At a predetermined operating pressure HD, the previously described relationship between the pivoting angle σₚₘₚ and the actuating pressure pₛₜ₁ or the actuating pressure difference Δpₛₜ is plotted.

The diagram shows spring forces: limitation of the angular dependence.

FIG. 6 shows a single characteristic curve, which illustrates the relationship between the high pressure HD of the axial piston pump (x axis) and the actuating pressure difference Δpₛₜ on the double-acting actuating cylinder 6. Here, account is taken of the fact that the axial piston pump can also act as a motor during overrun operation of the traction drive concerned. The pressure side in the axial piston pump is therefore changed, which is expressed by the negative operating pressure values HD. Accordingly, the second actuating pressure pₛₜ₂ must outweigh the first actuating pressure pₛₜ₁, which is illustrated by the negative values of the actuating pressure difference Δpₛₜ.

1. By actuating the operating element 24 equipped as an accelerator pedal, the driver increases the rotational speed n_{eng} of the diesel engine from idling to nominal rotational speed. In accordance with the eDA control, depending on the rotational speed n_{eng}, an activation signal is generated for the pressure reducing valves 18₁, 18₂ or their ET controllers. At nominal rotational speed, the maximum speed of travel is to be obtained, therefore the actuating pressure difference Δpₛₜ is raised to a specific value. Since there is still no load, the axial piston pump pivots out completely and supplies maximum volume flow Qₘₐₓ.

2. As a result of the driving resistances, during driving on the level a load pressure is established, for example 250 bar (Q point, the actuating pressure is set at nominal rotational speed such that the hydraulic output P*Q now corresponds to the nominal output of the diesel engine).

3. Under higher load (e.g. the mobile working machine is traveling uphill, picking up gravel), the operating pressure HD rises and the axial piston pump pivots back as a result of the restoring forces. The actuating pressure difference Δpₛₜ in the ET controller is, however, not reduced by pressure reducing valves 18₁, 18₂.

Disclosed is a hydrostatic axial piston pump for a hydrostatic traction drive having an adjusting unit for adjusting the stroke volume. The adjusting unit has an actuating cylinder with two counteracting actuating pressure chambers. An actuating pressure can be set in each actuating pressure chamber via a separate pressure reducing valve, the said activating pressure depending on and preferably being proportional to a current intensity on a respective solenoid of the respective pressure reducing valve. The two current intensities can be calculated via an electronic control unit on a model basis as a function of a rotational speed and of a operating pressure of the axial piston pump and as a function of an operating element for a driver's request, e.g. an accelerator pedal. In principle, the disclosure can also be applied to axial piston pump having only a single-acting actuating cylinder if no overrun operation is required, by the axial piston pump changing to a motor mode.

1. A hydrostatic axial piston pump for a hydrostatic traction drive, the axial piston pump comprising:
an adjusting unit configured to adjust a stroke volume, the adjusting unit including an actuating cylinder defining a first actuating pressure chamber in which a first actuating pressure is set via a first pressure reducing valve, the first actuating pressure depending on a first current intensity applied to a first solenoid of the first pressure reducing valve; and
an electronic control unit configured to determine the first current intensity based on an actual rotational speed, an operating pressure of the axial piston pump, and an operating element that receives a driver's request.

2. The hydrostatic axial piston pump according to claim 1, wherein the actual rotational speed and the first actuating pressure acts in a first direction of an increase in the stroke volume, while the operating pressure acts in a second direction of a reduction in the stroke volume.

3. The hydrostatic axial piston pump according to claim 1, wherein:
the hydrostatic piston pump is configured to be operated both as a motor and as a pump,
the actuating cylinder defines a second actuating pressure chamber, which acts counter to the first actuating pressure chamber and in which a second actuating pressure is set via a second pressure reducing valve, the said actuating pressure depending on a second current intensity applied to a second solenoid of the second pressure reducing valve, and
the electronic control unit is configured to determine the second current intensity based on the actual rotational speed, the operating pressure, and the operating element.

4. The hydrostatic axial piston pump according to claim 1, wherein the first pressure reducing valve is proportional such that the first actuating pressure is proportional to the first current intensity.

5. The hydrostatic axial piston pump according to claim 3, wherein the first and second pressure reducing valves are proportional such that the respective first and second actuating pressures are proportional to the respective first and second current intensities.

6. The hydrostatic axial piston pump according to claim 1, wherein the electronic control unit is configured to determine the first current intensity based on a characteristic map stored in the electronic control unit.

7. The hydrostatic axial piston pump according to claim 1, wherein the electronic control unit is further configured to determine a target pivoting angle of the axial piston pump on a model basis as a function of the operating element.

8. The hydrostatic axial piston pump according to claim 7, wherein the electronic control unit is further configured to determine the target pivoting angle using a volume flow balance.

9. The hydrostatic axial piston pump according to claim 1, wherein the electronic control unit is further configured to determine an output-guided actuating pressure, which is minimally linked with the first actuating pressure.

10. The hydrostatic axial piston pump according to claim 1, wherein feedback is provided, with which a speed controller is formed.
